(19) United States
(12) Patent Application Publication
(10) Pub. No.: US 2013/0254827 A1
(43) Pub. Date: Sep. 26, 2013

(54) METHOD, SYSTEM, SERVER AND TERMINAL FOR MANAGING DIGITAL TELEVISION BUSINESS DATA

(71) Applicants: Hongdong Tan, Shenzhen (JP); Yanbo Shen, Shenzhen (CN)

(72) Inventors: Hongdong Tan, Shenzhen (JP); Yanbo Shen, Shenzhen (CN)

(21) Appl. No.: 13/991,384

(22) PCT Filed: Feb. 28, 2011
(86) PCT No.: PCT/CN11/71391

§ 371 Date: Jun. 3, 2013

(30) Foreign Application Priority Data
Dec. 6, 2010 (CN) 201010574571.8

(51) Int. Cl. H04N 21/65

(52) U.S. Cl. CPC H04N 21/65
USPC 725/116

(57) ABSTRACT

A method, server and terminal for managing digital television business data are disclosed in the present invention. By means that the mobile terminal forwards a business request, which is required to be sent from a digital television reception terminal to a business server, to the business server and the business server provides the corresponding business service for a user via a unidirectional digital television network, the present invention solves the problem that the unidirectional digital television reception terminal in the art can not obtain bidirectional interactive television business data, and allows the user to enjoy bidirectional interactive television business functions without having to replace the digital television reception terminal and the unidirectional digital television network, thereby greatly enhancing user experience.

### CROSS REFERENCE TO RELATED APPLICATIONS

This application claims the benefit of priority to China patent application NO. 201010574571.8 filed in the Chinese Patent Office on Dec. 6, 2010 and entitled “METHOD, SERVER AND TERMINAL FOR MANAGING DIGITAL TELEVISION BUSINESS DATA”, the contents of which are incorporated herein by reference in their entirety.

### FIELD OF THE INVENTION

The present invention relates to digital television technical field, and more particularly, to management method, system, server and terminal for quickly transmitting digital television business data through different terminals.

### BACKGROUND OF THE INVENTION

With the popularity of digital television, Set-Top Boxes are used by more and more families to be family multimedia terminals. The Set-Top Boxes not only can realize the function of watching digital television, but also can realize the data broadcasting business function, such as Video-On-Demand, stock searching, shopping and entertainment information searching etc. As to the unidirectional digital television Set-Top Box in the art, it is incapable of digital television interaction business, such as interaction Video-On-Demand, shopping on internet, browsing the web etc. However, the user demand for the interactive business is constantly growing, the user very expect that realize such functions through unidirectional digital television Set-Top Box in the art. However, now there is not a system that can satisfy such user demand.

### SUMMARY OF THE INVENTION

The technical problem to be solved in the present invention is: to provide a method, system, server and terminal for managing digital television business data, to make a unidirectional digital television realize bidirectional interactive television business function through a mobile terminal.

To solve the aforesaid technical problem, the present invention discloses a method for managing digital television business data, includes the following steps:

a digital television reception terminal establishes a communication connection with a mobile terminal;

the digital television reception terminal sends a business request, which is required to be sent to a business server, to the mobile terminal;

the mobile terminal forwards the business request to the business server;

the business server processes the business request, generates corresponding business data, packages the business data into transport stream and pushes the transport streams to the digital television reception terminal;

the digital television reception terminal receives and processes the business data pushed by the business server.

To solve the aforesaid technical problem, the present invention also discloses a digital television reception terminal. The digital television reception terminal includes a control module, a frequency lock module, a communication module and an audio and video codecs displaying and processing module which are respectively connected to the control module;

the communication module, which is configured to establish communication connect with a mobile terminal;

the control module, which is configured to generate business request which is required to be sent to business server, sending the business request to the mobile terminal through the communication module so that after the mobile terminal forwards the business request to the business server, the business server can process the business request, generate corresponding business data, packages the business data into transport stream and pushes the transport streams to the digital television reception terminal;

the frequency lock module, which is configured to lock the frequency point of the transport streams and receiving the business data pushed by the business server;

the control module, which is configured to control the audio and video codecs displaying and processing module to process and display the business data pushed by the business server.

To solve the aforesaid technical problem, the present invention also discloses a mobile terminal. The mobile terminal includes a control module, a first communication module and a second communication module which are respectively connected to the control module;

the first communication module, which is configured to establish connection with digital television reception terminal and receiving business request which is required to be sent from the digital television reception terminal to a business server;

the control module, which is configured to control the second communication module to forward the business request to the business server according to the business request.

To solve the aforesaid technical problem, the present invention also discloses a business server. The business server includes a communication module, control module connected to the communication module, a data modulation module connected to the control module, and a data transmitting module connected to the control module and the data modulation module;

the communication module, which is configured to receive a business request forwarded by a mobile terminal, which is sent from a digital television reception terminal to the mobile terminal and is required to be sent to the business server, the forwarded business request carries identity authentication information and business request data of the digital television reception terminal;

the control module, which is configured to process the business request and generating corresponding business data;

the data modulation module, which is configured to package the business data into transport stream;

the data transmitting module, which is configured to push the transport stream to the digital television reception terminal.

To solve the aforesaid technical problem, the present invention also discloses a system for managing digital television business data. The system includes:

a digital television reception terminal, which is configured to establish communication connection with a mobile terminal and sending a business request to the mobile terminal which is required to be sent to a business server;

a mobile terminal, which is configured to forward the business request to the business server;

a business server, which is configured to process the business request, generating corresponding business data, packaging the business data into transport stream and pushing the transport stream to the digital television reception terminal;

the digital television reception terminal, which is also configured to receive and process the business data pushed by the business server.

Compared with the art, the present invention has the beneficial effects as follows: by means that a mobile terminal forwards a business request, which is required to be sent from a digital television reception terminal to a business server, to the business server, and the business server provides the corresponding business service for a user via a unidirectional digital television network, the present invention solves the problem that the unidirectional digital television reception terminal in the art can not obtain bidirectional interactive television business data, and allows the user to enjoy bidirectional interactive television business functions without having to replace the digital television reception terminal and the unidirectional digital television network, thereby greatly enhancing user experience.

### BRIEF DESCRIPTION OF THE DRAWINGS

FIG. 1 is a flowchart of a method according to an embodiment of the present invention;

FIG. 2 is a structure diagram of a digital television reception terminal according to an embodiment of the present invention;

FIG. 3 is a structure diagram of a mobile terminal according to an embodiment of the present invention;

FIG. 4 is a structure diagram of a business server according to an embodiment of the present invention.

### DETAILED DESCRIPTION OF ILLUSTRATED EMBODIMENTS

Further description of the present invention will be illustrated, which combined with embodiments and drawings, in order to make the technical schemes clearer and completely. Obviously, the embodiments described herein are only a part of embodiments, but not all of embodiments. Based on the embodiments of the present invention, all of other embodiments obtained by the person skilled in the art who have not do any creative labor should be fallen within the protection scope of the present invention.

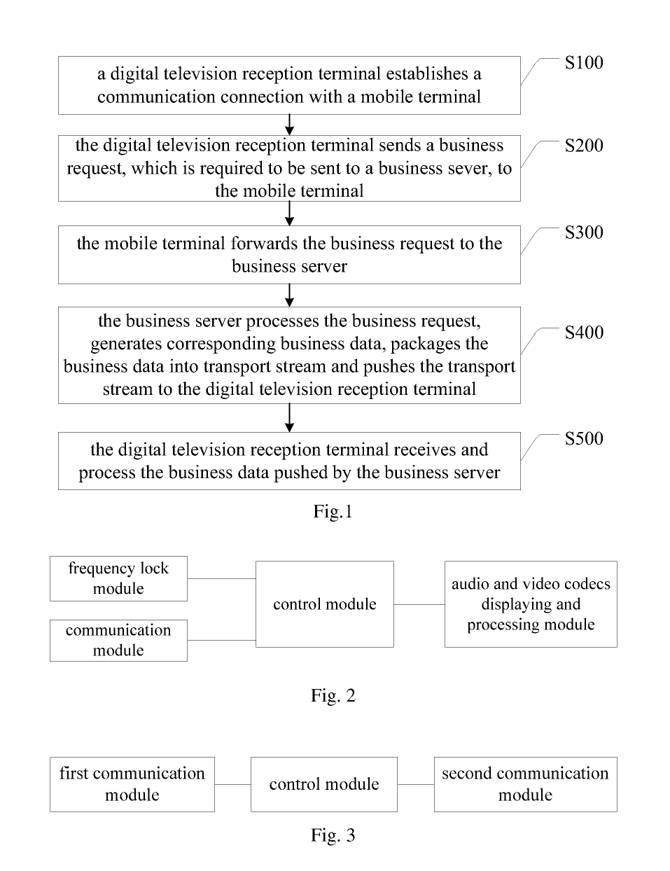

As shown in FIG. 1, the present invention provides a method for managing digital television business data. The method includes the following steps:

S100: a digital television reception terminal establishes a communication connection with a mobile terminal ;

S200: the digital television reception terminal sends a business request, which is required to be sent to a business server, to the mobile terminal;

S300: the mobile terminal forwards the business request to the business server;

S400: the business server processes the business request, generates the corresponding business data, packages the business data into transport stream, and pushes the transport streams to the digital television reception terminal;

S500: the digital television reception terminal receives and processes the business data pushed by the business server.

Further, the step S100 of a digital television reception terminal establishing a communication connection with the mobile terminal, includes:

S101: the digital television reception terminal sends a connection request message to the mobile terminal;

S102: the mobile terminal receives the connection request message. If the mobile terminal determinates that the mobile terminal can communicate with the digital television reception terminal, returning a respond message;

S103: if the digital television reception terminal receives the respond message from the mobile terminal within a fixed period of time, the digital television reception terminal is connected to the mobile terminal. Otherwise, the digital television reception terminal returns a failure message and exiting.

Further more, the step 5200 of the digital television reception terminal sending a business request, which is required to be sent to a business server, to the mobile terminal, includes:

S201: the digital television reception terminal obtains an instruction of requesting an interactive television business from a user;

S202: generating a corresponding business request according to the instruction, wherein, the business request includes a network address of a business server that may provide the interactive television business (such as internet protocol address) and related business demand data (such as the time, date, city and weather forecasting business identity number of requesting to search weather forecasting, or a name and video-on-demand business identity number of a film requested to be on demand).

S203: sending the generated business request to the mobile terminal.

In the embodiment, the digital television reception terminal may communicate with the mobile terminal by a short distance communication protocol, such as blue-tooth, wireless fidelity (WIFI) and infrared. The digital television reception terminal may also communicate with the mobile terminal by mobile wireless communication protocol such as global system for mobile communications (GSM) and code division multiple access (CDMA). For example, the digital television reception terminal sends the connection request and the business request to a pre-bundled mobile terminal by means of sending a short message.

In the embodiment of the present invention, before the step S300 of the mobile terminal firstly forwarding the business request to the business server, the method further includes:

S600: the mobile terminal obtains and stores identity authentication information of the digital television reception terminal, such as a mark that can uniquely indentify the identity of the digital television reception terminal, like a user name of a digital television user, an identity card number or a conditional access smart card number of the digital television reception terminal.

The step S600 includes the following steps:

S601: the mobile terminal sends a download request to the digital television reception terminal, to require to download the identity authentication information of the digital television reception terminal;

S602: the digital television reception terminal receives the download request, returns a respond message and sends the identity authentication information to the mobile terminal;

S603: the mobile terminal receives and stores the identity authentication information of the digital television reception terminal. After the mobile terminal stored the identity authentication information of the digital television reception terminal, when the mobile terminal forwarding the business request again, it is not necessary to obtain the identity authentication information from the digital television reception terminal. The mobile terminal can directly transmit the stored identity authentication information to the business server.

In addition, in the embodiment of the present invention, the identity authentication information of the digital television reception terminal can be sent to the mobile terminal with the business request, when the digital television reception terminal firstly sends the business request to the mobile terminal. Or the identity authentication information of the digital television reception terminal is sent to the mobile terminal when the digital television reception terminal is connected to the mobile terminal. So that the step of the mobile terminal obtaining the identity authentication information from the digital television reception terminal can be omitted.

Further more, the step S300 of the mobile terminal transmitting the business request to the business server, includes:

S301: the mobile terminal receives and analyzes the business request;

Specifically, after the mobile terminal receives the business request, the mobile terminal analyzes the network address information of the business server and the business demand data carried in the business request. When mobile terminal determines that it is necessary to provide the service of transmitting the business request for the digital television reception terminal, the mobile terminal prompts the user whether to do the transmitting service, and receives a confirmation message returned by the user. If the transmitting service needs to do, the step S302 is implemented. Otherwise, exiting , and returning an error message to the digital television reception terminal.

S302: the mobile terminal is connected to the corresponding business server according to the network address message of the business server carried in the business request;

Specifically, the mobile terminal can be connected to the business server via GPRS or 3G communication network.

S303: forwarding the business request, which is composed of the stored identity authentication information of the digital television reception terminal and the business demand data, to the business server.

Further more, the step S400 of the business server processing the business request, generating corresponding business data, packaging the business data into transport stream and pushing the transport streams to the digital television reception terminal, includes:

S401: the business server receives and analyzes the business request forwarded by the mobile terminal;

Specifically, after the business server receives the business request, the business server analyzes the identity authentication information of the digital television reception terminal and the business demand data from the business request. When the business server determines that it is necessary to provide interactive television business for the digital television reception terminal, the step S402 is implemented. Otherwise, returning a fault message to the mobile terminal.

S402: verifying the identity authentication information of the digital television reception terminal, if passed the verification, processing the business request, otherwise, returning an error message;

S403: generating the corresponding business data according to the business demand data;

Specifically, the business server judges which kind of interactive television businesses needed to be provided according to the business demand data. (For example, judges through business ID number in the business demand data and other related information). And then, the business server generates the business data using the data, adapted to the business request of the digital television reception terminal, in the interactive television business.

S404: packaging the business data into the transport stream;

S405: pushing the transport stream to the digital television reception terminal through the unidirectional digital television network.

Specifically, before pushing the business data, the business server distributes corresponding frequency points for the business data according to the actual remainder bandwidth condition of the current network bandwidth. If the remainder bandwidth of the current network is big, the business server distributes more frequency points for the business data to send the business data. Otherwise, the business server distributes less frequency points for the business.

Specifically, the business server pushes the transport stream to the digital television reception terminal by means of data carousel or object carousel. The digital television reception terminal needs to receive the transport stream within the period of validity ruled by the business server. Otherwise, out of the period of validity, the business data cannot be sent.

In the embodiment of the present invention, the transmission media of the unidirectional digital television network may be cable transmission media, ground transmission media or satellite transmission media.

Further more, the step S500 of the digital television reception terminal receiving and processing the business data pushed by the business server, includes:

S501: the digital television reception terminal locks the frequency point of the transport stream and receives the business data;

S502: processing and displaying the business data.

To further make the user to store the received business data, after the step S502, the method may also include S503: storing the business data according to a storage request from the user.

Here, it illustrates the embodiments of the present invention in detail by a specific application scenarios.

If a user A requires a film F on demand, a required business movie on demand is selected in a user business request input interface displayed by the digital television reception terminal through the remote controller. And the corresponding film name F is selected or input, and then the user confirms it. After the digital television reception terminal obtains the request instruction of the movie-on-demand F confirmed by the user, the digital television reception terminal generates the corresponding business request. The business request carries the network address information of the business server and the business demand data. And the digital television reception terminal is connected to the mobile terminal, to sends the business request to the mobile terminal of the user.

After the mobile terminal receives the business request, the mobile terminal analyzes the business request, sends a prompt message whether to forward the business request to the business server to the user. If the user clicks the confirmation, the mobile terminal forwards the business request, which is composed of pre-stored identity authentication information of the digital television reception terminal and business demand data, to the business server. Otherwise, exiting.

After the business server receives the business request, the business server analyzes the business request, and searches the film F on demand from the video server or database. And then the business server packages it into the transport stream, and pushes the film F to the digital television reception terminal through the specific frequency point distributed before.

The digital television reception terminal locks the specific frequency point, receives the transport stream, and processes the codec of audio and video, and plays the film F.

In addition, as shown in FIG. 2, a digital television reception terminal is also provided in the embodiment of the present invention. The digital television reception terminal includes: a control module, a frequency lock module connected to the control module, a communication module, which is configured to communicate with a mobile terminal, connected to the control module, and an audio and video codecs displaying and processing module connected to the control module;

the communication module, which is configured to establish a communication connect to a mobile terminal;

the control module, which is configured to generate business request which is required to be sent to business server, send the business request to the mobile terminal through the communication module;

the frequency lock module, which is configured to lock the frequency point of the transport streams and receive the business data pushed by the business server;

the control module, which is configured to control the audio and video codecs displaying and processing to process the business data pushed by the business server.

Wherein, the control module is also configured to send identity authentication information of the digital television reception terminal to the mobile terminal through the communication module.

Further more, to make the user to store the received business data, the digital television reception terminal in the embodiment of the present invention also comprises a storing module connected to the control module, which is configured to store the business data according to the control of the control module. The storing module may be hard disk or flash memory inside the digital television reception terminal, also may be external memory connected to the digital television reception terminal by the interface such as USB(Universal Serial BUS).

The particular operational principle and realizing flow of the digital television reception terminal in the embodiment of the present invention have been described as is stated above, here they will not be repeated again.

In the embodiment of the present invention, the digital television reception terminal includes but does not limit to the terminal having the function of receiving digital television, such as Set-Top Box, IPTV(Internet Protocol Television), digital television integrated machine.

As shown in FIG. 3, the mobile terminal provided by the embodiment of the present invention includes a control module, a first communication module, which is configured to communicate with the digital television reception terminal, connected to the control module, and a second communication module, which is configured to communicate with the business server, connected to the control module;

the first communication module, which is configured to establish connection with digital television reception terminal and receive business request which is required to be sent from the digital television reception terminal to a business server;

the control module, which is configured to control the second communication module to forward the business request to the business server according to the business request.

Wherein, the mobile terminal in the embodiment of the present invention also includes a storing module connected to the control module.

The first communication module is also configured to receive identity authentication information of the digital television reception terminal sent from the digital television reception terminal; the control module controls the storing module to store the identity authentication information of the digital television reception terminal.

Particularly, the business request received by the mobile terminal and sent from the digital television reception terminal carries a network address information of the business server and business demand data.

The control module analyzes the business request, controls the second communication module to establish a communication connection with corresponding business server according to the network address information of the business server carried by the business request, and forwards the new business request, which is composed of the identity authentication information of the digital television reception terminal and the business demand data, to the business server.

The particular operational principle and realizing flow of the mobile terminal in the embodiment of the present invention have been described as is stated above, here they will not be repeated again.

In the embodiment of the present invention, the mobile terminal comprises the mobile communication device comprising but not limiting to mobile telephone, Personal Digital Assistant (PDA), portable computer and panel computer.

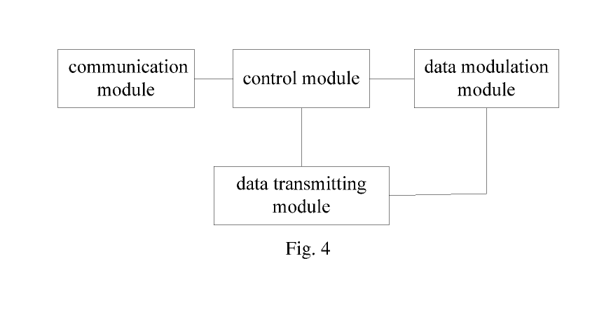

As shown in FIG. 4, the business server provided by the embodiment of the present invention includes a communication module for establishing a communication connection with a mobile terminal, a control module for controlling the process of the business server connected to the communication module, a data modulation module connected to the control module, and a data transmitting module for transmitting the data of transport stream connected to the control module;

the communication module receives a business request forwarded by a mobile terminal, the forwarded business request carries identity authentication information and business request data of the digital television reception terminal;

the control module processes the business request and generates corresponding business data;

the data modulation module packages the business data into transport stream;

the data transmitting module pushes the transport stream to the digital television reception terminal.

In addition, the business server in the embodiment of the present invention also includes identity authentication module for verifying the identity authentication information of the digital television reception terminal, if passed the verification, the control module processes the business request, otherwise, returns an error message.

Particularly, the control module generates corresponding business data according to the business demand data.

Particularly, the data transmitting module pushes the business data to the digital television reception terminal via a unidirectional digital television network in the art. Before the data transmitting module pushing the business data, the business server distributes corresponding frequency point for the business data according to the actual remainder bandwidth condition of the current network bandwidth, if the remainder bandwidth of the current network is big, may distributing more frequency points for the business data to send the business data. Otherwise, the business server distributes less frequency points for the business.

The particular operational principle and realizing flow of the business server in the embodiment of the present invention have been described as is stated above, here they will not be repeated again.

In conclusion, in the embodiments of the present invention, by means that the mobile terminal forwards a business request, which is required to be sent from a digital television reception terminal to a business server, to the business server and the business server provides the corresponding business service for a user via a unidirectional digital television network, the present invention solves the problem that the unidirectional digital television reception terminal in the art can not obtain bidirectional interactive television business data, and allows the user to enjoy bidirectional interactive television business functions without having to replace the digital television reception terminal and the unidirectional digital television network, thereby greatly enhancing user experience.

The preferred embodiments described above further illustrate specifically the purpose, technical schemes and advantages of the present invention, it should be understood that what are said above are only preferred embodiments of present invention, not intended to limit the present invention, any modifications, equivalent substitutions and improvements etc. made within the spirit and principle of the present invention, should be included in the protection range of the present invention, the right ranges of the present invention claimed for should be based on the ranges of the invention claimed for, not only be limited to the above embodiments.

1. A method for managing digital television business data, comprising:
a digital television reception terminal establishing a communication connection with a mobile terminal;
the digital television reception terminal transmitting a business request, which is required to be sent to a business server, to the mobile terminal;
the mobile terminal forwarding the business request to the business server;
the business server processing the business request, generating corresponding business data, packaging the business data into transport stream and pushing the transport streams to the digital television reception terminal;
the digital television reception terminal receiving and processing the business data pushed by the business server.

2. The method for managing digital television business data of claim 1, before the step of the mobile terminal forwarding the business request to the business server, the method further comprising:
the mobile terminal obtaining and storing identity authentication information of the digital television reception terminal;
the business request sent from the digital television reception terminal to the mobile terminal carrying network address information and business demand data of the business server.

3. The method for managing digital television business data of claim 2, the step of the mobile terminal forwarding the business request to the business server , comprising:
the mobile terminal receiving and analyzing the business request;
establishing a communication connection with corresponding business server according to the network address information of the business server carried in the business request;
forwarding the business request, which is composed of identity authentication information stored in the digital television reception terminal and the business demand data, to the business server.

4. The method for managing digital television business data of claim 3, the step of the business server processing the business request, generating corresponding business data, packaging the business data into transport stream and pushing the transport streams to the digital television reception terminal, comprising:
the business server receiving and analyzing the business request forwarded by the mobile terminal;
verifying the identity authentication information of the digital television reception terminal;
when passed the verification, generating corresponding business data according to the business demand data;
packaging the business data into transport stream;
pushing the transport stream to the digital television reception terminal via a unidirectional digital television network.

5. The method for managing digital television business data of claim 4, the step of the digital television reception terminal receiving and processing the business data pushed by the business server, comprising:
the digital television reception terminal locking a frequency point of the transport stream and receiving the business data;
processing and displaying the business data.

6. A digital television reception terminal, comprising: a control module, a frequency lock module, a communication module and an audio and video codecs displaying and processing module which are respectively connected to the control module;
the communication module, which is configured to establish communication connect with a mobile terminal;
the control module, which is configured to generate business request which is required to be sent to business server, send the business request to the mobile terminal through the communication module so that after the mobile terminal forwarded the business request to the business server, the business server can process the business request, generate corresponding business data, packages the business data into transport stream and pushes the transport streams to the digital television reception terminal;
the frequency lock module, which is configured to lock the frequency point of the transport streams and receiving the business data pushed by the business server;
the control module, which is configured to control the audio and video codecs displaying and processing module to process and display the business data pushed by the business server.

7. The digital television reception terminal of claim 6, the control module, which is also configured to send identity authentication information of the digital television reception terminal to the mobile terminal through the communication module.

8. The digital television reception terminal of claim 6, further comprising: storing module, which is connected to the control module and is configured to store the business data according to the control of the control module.

9. A mobile terminal, comprising a control module, a first communication module and a second communication module which are respectively connected to the control module;
the first communication module, which is configured to establish connection with digital television reception terminal and receive business request which is required to be sent from the digital television reception terminal to a business server;
the control module, which is configured to control the second communication module to forward the business request to the business server according to the business request.

10. The mobile terminal of claim 9, further comprising:
a storing module, which is connected to the control module;
the first communication module, is also configured to receive identity authentication information of the digital television reception terminal sent from the digital television reception terminal;
the control module, which is also configured to control the storing module to store the identity authentication information of the digital television reception terminal;
the business request received by the first communication module carries network address information and business demand data of the business server.

11. The mobile terminal of claim 10, the control module is specifically configured to analyze the business request, control the second communication module to establish a communication connection with corresponding business server according to the network address information of the business server carried by the business request, and forward the business request which is composed of identity authentication information of the digital television reception terminal and the business demand data to the business server.

12. (canceled)

13. (canceled)

14. (canceled)

15. (canceled)

16. (canceled)

17. The digital television reception terminal of claim 7, further comprising: storing module, which is connected to the control module and is configured to store the business data according to the control of the control module.
